(19) United States
(12) Patent Application Publication
(10) Pub. No.: US 2016/0334235 A1
(43) Pub. Date: Nov. 17, 2016

(54) ITPA INFORMED TRAVELER PROGRAM AND APPLICATION

(71) Applicant: The Florida International University Board of Trustees, Miami, FL (US)

(72) Inventors: Thomas F. Gustafson, Wellington, FL (US); Naphtali Rishe, Miami Beach, FL (US); Ramon Trias, Miami, FL (US); Kenneth Stapleton, Bay Harbor Island, FL (US)

(21) Appl. No.: 14/589,809

(22) Filed: Jan. 5, 2015

Related U.S. Application Data
(63) Continuation-in-part of application No. 13/847,024, filed on Mar. 19, 2013, now abandoned.

(51) Int. Cl. G01C 21/34

(52) U.S. Cl. CPC G01C 21/3492

(57) ABSTRACT

A method of informed, multi-modal travel by a user choosing from potential routes to a defined destination includes using real-time travel-related data derived from a plurality of inputs of present traffic flow, emergency and scheduled events, weather, historic traffic trends, and parking conditions at a definite final destination; providing outputs of the process; generating spatial analysis of real-time traffic flow; applying predictive and analytical models with rule-based constraints to selective outputs of these steps; and providing informed traveler user and management mobile access portals. A customer-oriented analytical system supports large-scale transportation management and provide useful information to travelers allowing them to make informed decisions regarding time, duration and mode of travel along with alternative multimodal routes. The system and method are a way of distributing travelers by time, space and mode in order to optimize travel and traffic management.

### REFERENCE TO RELATED APPLICATIONS

This application claims the benefit under 35 USC 119 (e) of Provisional Patent Application Ser. No. 61/612,932, filed Mar. 19, 2012, as well as serves as a continuation in part of patent application Ser. No. 13/847,024 filed Mar. 19, 2013, which same applications are herewith incorporated in their entirety by reference.

### BACKGROUND OF THE INVENTION

Inefficiencies of the present situation of sole dependence only on the private automobile and congested highways cost U.S. commuters 4.2 billion hours, 2.8 billion gallons of fuel, and $200 billion per year, not to mention road rage. The Informed Traveler Program and Application (“ITPA”) employs a smartphone and personal electronic device based interface to provide personalized, timely information and advice regarding the most efficient and cost-effective travel paths consistent with the traveler's destination and schedules. This includes information about whether to use transit, delay the start of a trip to avoid congestion, or take an alternate route to avoid rush hour, construction, accident or other delays. It is a predictive and real time decisional system that integrates large volumes of stochastic data into an end-user's choice process. It takes into account specific user needs and travel or medical limitations when providing travel information and choices. It provides specific guidance as to timing allowed for and directions during intermodal transfers. The system is constantly predictive in nature, utilizing environmental, real time and archival data to allow the end user to make better travel decisions even before entering a private vehicle. It also offers ITPA users the holistic possibilities of express transit routes and faster parking in “smart” garages associated with the system, which is a major time saver. It works on smart phones and mobile computing devices, and has both audio and visual capabilities similar to standard GPS-based devices, but possesses intelligence beyond these standard capabilities that considers user needs, situational conditions, multimodal and intermodal options, and safety and environmental concerns, to produce a customized and holistic solution.

This unique application of innovative technology and computational power to transit is a pioneering step intended to serve as a model for communities throughout the nation. IPTA thereby arms travelers with both the information and the confidence, through experiential reinforcement arising from continued IPTA use, to delay travel plans, change routes, or take public transit instead of following a reflexive pattern of automotive travel. It must thus be seen that the intelligent system is not only continuously and iteratively training itself but is also training the end-user and their choices.

An ITPA user will no longer thoughtlessly jump into a private vehicle without synergistically combining, when warranted, other forms of transport including bus, ferry/water taxi, transit, bicycle, underground, and even walking in the alternative sequences suggested by ITPA. ‘Stop and Go’ can translate into a smooth ‘Fast and Slow’. Depending on the need, services like Smart Cars and Uber could be integrated into the system.

For a better understanding of how the ITPA can benefit users, consider the following three scenarios, whose examples below are summarized for better understanding.

### Example A

### Annette Got a Late Start from Home

A third of the way on her commute, she discovers through ITPA, which uses not only real-time traffic information, but also historical inputs and alerts her of arterial highway congestion. She is given the following information.

1. Congested traffic on the normal arterial route.
2. Time and cost benefits of choosing one of several mass transit alternatives by exiting the arterial route.
3. Alternatively rescheduling the appointment and waiting at the next exit and profitably using the time either for shopping or working on her laptop.

Annette is in a rush and she takes ITPA advice to park at the Sheridan Street Tri-Rail Station two exists southward of her current location and take the Tri-Rail train that ITPA says is scheduled to leave within five minutes after her projected Sheridan Station arrival. ITPA confirms that the train is expected to arrive on time.

ITPA's assistance includes indicating parking spots at the destination in the most convenient smart-garage associated with the system. Consequently Annette arrives more refreshed and suffers less stress while starting her day's work.

A colleague of Annette who was also informed by ITPA of congested conditions on the highway nevertheless consciously chooses to bring his car to the office. He has an overriding need to keep his car with him for onward travel during the day.

### Example B

Francisco would have missed his appointment but for the ITPA system locating a parking spot and reserving it in the smart garage nearest to his appointment.

### Example C

Jose does not have a car. He relies on ITPA for transit guidance.

### DESCRIPTION OF RELATED ART

Several existing patents suggest an intelligent traffic navigating and routing system with several inputs for guidance. Others cover vehicle safety and parking monitoring. None, however, actually takes into account all the variables of the present ITPA system and indeed none approaches the intelligent algorithmic functionality that ITPA provides.

U.S. Pat. No. 7,957,871 B1 issued to Echeruo on Jun. 7, 2011, assigned to Hopstop.com, Inc. in New York City discloses a Method and Apparatus for Navigation in Urban Environments, whose embodiments include methods, systems, and apparatuses for providing maps and directions, including walking and mass transit directions in urban environments where users do not drive cars. Additionally, driving directions can be included. Only certain preferences, such as amount of walking, for or against use of particular streets, certain mass transit vehicle types, as well as the number of transfers between mass transit vehicles, are considered in the routing calculations, as well as non-individual information such as current conditions and other information. The system provides for a user feedback loop to determine subsequent routing decisions. The invention also provides web services including textual and graphic input for third parties, such as the travel industry, to access such services and for clients to edit mass transit information. Specifically the system teaches away from and does not provide for integration of the use of a personal vehicle. Moreover, it does not provide for analytics of archival data, historic patterns, or crowd-sourced data. It largely consists of a path-solver based on an extension to Dijkstra's algorithm.

United States Patent Application US 2005/0021224 A1 by Gray, published Jan. 27, 2005, discloses a control system which activates countermeasures to hazards indicated by a database and by information systems external to a vehicle by activating a plurality of vehicle systems. This control system analyzes location and time information regarding multiple situations that may coincide with the path of the vehicle and controls vehicle systems to provide countermeasures to hazards when probability of encountering those hazards meets a sufficient threshold. The system is an advanced vehicle and road safety tool but in no way rises to the level of a routing or traffic control system at the macro level and simply provides for making driving safer as opposed to combining vehicle use with transit in a smart way so as to optimize a client's time and expense and leave a greener carbon footprint for the environment.

United States Patent Application US 2002/0109610 A1 by Katz, published Aug. 15, 2002, for a Parking Status Control System and Method, discloses a parking status control system and method allowing a parking space, or plurality of parking spaces, to be automatically monitored to detect unauthorized use. The system and method may be applied to metered parking spaces or to situations where controlled access to a parking space or area is desired. Presence of a vehicle in a monitored parking space is determined using a vehicle presence detector, which communicates a signal indicative of such presence to a central system. A user or vehicle based authorization module is configured to transmit an authorization input to facilitate automated satisfaction of a space authorization device, e.g., payment of a parking meter. Where the space is detected as occupied without proper authorization, the central system declares a violation and communicates this to another system or individual charged with taking corrective action. The system does not discuss monitoring of all parking spaces within a given vicinity or neighborhood by a central system and integration with an intelligent commuter based solution.

United States Patent Application Publication US 2009/0005963 A1 by Jarvinen, published Jan. 1, 2009 and assigned to Nokia Corporation, discloses an apparatus for providing improved route planning, which may include a processing element. The processing element may be configured to receive calendar information from at least one driver and at least one passenger that are each registered to a service having a routing functionality, and determine a transportation plan including a travel route based on the received calendar information.

United States Patent Application Publication US 2011/0208417 A1 by Fink et al., published Aug. 25, 2011, for a System and Method of Representing Route Information, assigned to Research in Motion, wherein a route comprises interconnected road segments which may be traveled to get from one location to another (fixed destination), wherein a route is represented as a scaled linear shape, whose portions represent portions of the route, regardless of spatial arrangement of the apportioned segments. A scale is applied between characteristics of the route and the linear shape, integrating information elements along the linear shape which correspond, according to the scale, to locations on the route corresponding to these information elements, and allowing for color-coding or cross-hatching to represent traffic congestion. Incident reports may also be represented by indicators along the linear shape. Alternative routes, such as detours, may be represented by respective separate linear shapes; lead lines may connect such alternative route linear shapes to points along the primary route linear shape where each such detour or alternative would be taken. This system is a perfect route indicator and uses very instructive coding, but does not really take into account integrating multiple modes of transportation, or optimization of a user's schedule or time.

U.S. Pat. No. 7,761,225 B2 issued to Vaughn on Jul. 20, 2010, assigned to IBM, discloses a routing method and system. The method includes receiving a user profile via a GPS transceiver, which comprises user preference data and destination location data. The GPS transceiver also retrieves first geospatial coordinate values for the user's current as well as destination location. The GPS transceiver then processes the user profile and the first geospatial coordinate values to identify a geographical route for traveling from the current location to the destination location. The GPS transceiver retrieves current and historical traffic speed and density data associated with second geospatial coordinate values for various locations located along the first geographical route, and processes the data to determine if the first geographical route comprises an efficient route for the user.

U.S. Pat. No. 7,741,977 B2 issued to Buchalo et al. on Jun. 22, 2010, assigned to Motorola, discloses a method and apparatus for calculating the travel time of a vehicle as it transits through multiple locations. It includes a device for detecting a radio signal from a vehicle, attaching information to the radio signal, and transmitting a message packet with the signal and attached information to a central server, which then stores the packet. The central server compares the information in the message packet against other stored message packets received from multiple locations. When matching information is found, an algorithm is run to compute a vehicle travel time between two locations.

U.S. Pat. No. 6,317,686 B1 issued to Ran on Nov. 13, 2001, assigned to Trafficcast.com, discloses a method of providing travel time, comprising a traffic information system for predicting travel times that utilizes Internet-based collecting and disseminating of information. The system accounts for vehicle type, driver specific disposition, and its predictions of future traffic account for the effects of predictable events, particularly weather, on traffic patterns. The traffic information system includes a computer model of a transportation route map, the route map having a multiplicity of possible destinations points connected by route segments. An equation is developed for each route segment, the equation incorporating variables and constants which relate to the fixed and variable parameters which are indicative of the time it will take to travel along a particular route segment. Predicted travel time along the route segment can be improved over historical data for a time in the future for which there are reasonably accurate weather predictions. Incorporation of the effect of predicted weather on travel time over a route segment can be accomplished by developing a correlation between weather conditions and decreased traffic speeds. Personalized prediction times are generated by taking into account the vehicle type and level of aggressiveness of a particular driver.

U.S. Pat. No. 5,687,360 issued to Chang on Nov. 11, 1997, assigned to Intel, discloses a branch predictor using multiple prediction heuristics and a heuristic identifier in the branch instruction, wherein, in a computer program, a branch instruction selects a prediction heuristic from a plurality of prediction heuristics for predicting whether the particular branch will be taken during execution of the program by a computer. A current pattern comprises a number of consecutive identical branch decisions for the instruction. A prior pattern comprises a number of consecutive identical prior branch decisions for the instruction, the prior branch decisions occurring prior to the branch decisions comprised by the current pattern. The selected prediction heuristic generates a branch prediction using the current pattern and the prior pattern. The selected prediction heuristic is identified by adding profiling instructions to the program to compute history information for the branch instruction. The profiling instructions input the branch history information to a plurality of prediction heuristics, and each prediction heuristic outputs a prediction of whether the branch instruction will be taken. The program is executed with a sample data set, and the output of each prediction heuristic is compared to the branch decision for the instruction to identify which heuristic most accurately predicts the branch decision for the branch instruction.

### SUMMARY OF THE INVENTION

The Informed Traveler Program and Applications (ITPA) is an advanced travel advisory system that provides its smart phone-based users with predictive analytical information as to multimodal travel routing and parking options. This commuter-oriented analytical system supports large-scale transportation demand management and provide useful information to travelers allowing them to make informed decisions regarding: time and duration of travel; choices of mode of travel; and alternative non-direct multimodal routes. By this means, ITPA is intended to provide travel advice to help distribute its users in time and space and by mode of travel in order to optimize: individual ITPA customer trips; the choice of options which may be availed when trips are delayed; as well as multimodal transportation system capacities and relief of congestion on major traffic arteries.

ITPA informs travelers who are ITPA customers of the best possible options available to them given a full understanding of choices in space, over time and by mode using predictive analysis. Such an array of options is not seen in the prior art.

As ITPA predicts if one segment of the transportation fills up or is not otherwise available to be timely used based on predictive departure and arrival times, travelers are dispersed to minimize trip segment times and costs and so as to avoid unsafe or maybe unpleasant conditions and so as to usefully put to use time before trip starts and after trip ends as well as during intermodal transfer times. By this means, travel is optimized for each ITPA customer given system capacity to deliver multimodal transport, timely intermodal transfers and desired ETAs are selected destination.

The present invention further relates to a method of informed decision making in multi-modal travel to a definite final destination via a plurality of potential routes comprising the following steps: 1. Utilizing of real-time travel-related data relative to a plurality of inputs such as present traffic flow, emergency events, roadway construction, special community events, weather, historic traffic-affecting trends, and parking conditions at the informed traveler's destination to calculate a plurality of potential decisional outputs; 2. Archiving at least one such decisional output of the first step to a historical archival database of decisional outputs/decisions/choices; 3. Generating a current spatial analysis of real-time traffic flow; 4. Applying predictive and analytical computational models, such as goal planning, heuristic methods and fuzzy logic, using rule-based constraints to selective decisional outputs of the first and third steps; 5. Identifying, verifying, authenticating authorized users; and 6. Providing electronic access portals to the informed traveler.

The present method of providing traveler guidance to reach a predetermined destination in a multi-modal transit network may further comprise the following steps: 1. Establishing a database including a matrix of daily routes of category A trains, inclusive of times of day at each station or stop thereof, said stations or stops within a commutable distance of said pre-determined destination, the trains including any mode of fixed guide-way transit (such as trains, trams, trolleybuses, and the like); 2. Establishing a database including a matrix of daily routes of Category B trains and Category B express buses having routes that include a common station or transfer point of intersection within the route of at least one of said Category A trains, the stops and stations of these category B trains and buses within a commutable distance of the final destination; 3. Establishing a database including a matrix of daily routes of local buses or community transit vehicles of Category C within a commutable distance of said destination, at least one of said routes having a common stop, station or transfer point of intersection with at least one of the routes of said trains or buses of category A or B; 4. Monitoring real-time traffic conditions upon major road arteries within the commutable distance of the final destination; 5. Monitoring real-time events of actual and prospective vehicle congestion, by sector, upon said major arteries within said communicable distance, and generating wireless alerts to concerned travelers when definable actual or prospective vehicle congestion occurs; and 6. Generating, for use by actual and prospective en-route travelers on the major arteries, suggestions of alternative routing by transferring to a train station of said Category A or B trains, or bus routing to the final destination, by electronically overlaying or querying said matrices of said databases regarding the schedules of Category A trains, Category B trains or buses, and Category C local buses or community transit vehicles, to determine stops or stations thereof in the vicinity of the traveler upon the said major artery, allowing the traveler, should he wish, to park his vehicle and, within a user acceptable timeframe, board a train or bus and thereafter, as necessary, board a second train or bus to more efficiently reach the pre-determined destination.

An objective of IPTA is to provide the traveler or commuter with the benefits of a basic Intelligent Transportation System (ITS) along with the benefits of a modeling system that predicts traffic conditions hours before they occur such that it can advise the ITPA users how to make optimum use of the existing transportation capacity through large-scale Transportation Demand Management (TDM) strategies. When applied to a multitude of individual informed travelers, the need to build additional highway capacity is reduced and the ridership and customer revenues of mass transit are increased.

Another objective of the system is to significantly reduce traffic congestion.

A yet further objective is to enable transportation agencies to collect real-time data needed to measure and improve the performance and capacity of the transportation system by the least expensive means possible, making ITPA the centerpiece of efforts to reform surface transportation system and hold providers accountable for results.

A still further objective is to use advanced information technology platforms, advanced computing architecture, ITS, predictive modeling systems, specific traveler interests and needs, and smartphone-based software, to substantially reduce: vehicle miles traveled; greenhouse gas (GHG) emissions; and travel time, costs, and stress.

Another object of the invention is to provide to transportation system managers an expert transportation information system planning tool for their communities, which identifies locations where, despite the operation of the system, traffic bottlenecks in fact still accumulate, so that they can better plan how best to scale multimodal transportation capacity in the future by projecting the existence of alternative multimodal improvements and determining by scenario which alternative performs best in optimized traffic conditions through benefits and costs analysis.

The above recited objects and advantages of the present invention will become apparent from the hereinafter set forth Brief Description of the Drawings, Detailed Description of the Invention and Claims appended herewith, but are not intended to limit the scope of the invention.

### BRIEF DESCRIPTION OF THE DRAWINGS

FIG. 1 is a non-technical overview of the ITPA system.

FIG. 2 is an architectural overview of the ITPA system

FIG. 3 shows the architecture of the ITPA smart-phone application

FIG. 4 shows examples of user screens for the smart-phone application

FIG. 5 shows the architecture of the control or operations center module of the ITPA

FIG. 6 shows the architecture of the ITPA Computational Service

FIG. 7 shows the architecture of the ITPA Communications and Data Services

FIG. 8 shows the architecture of the ITPA Vehicle Interaction Module

FIG. 9 shows an example of a use case of ITPA with transportation information.

FIG. 10 is a flow chart of use of the ITPA system with community and express buses and other public ground transit vehicle.

FIG. 11 is a flow chart showing a typical use of ITPA by a student.

FIG. 12 is a flow chart of an integrated private vehicle and public rail transit use of the system.

### DETAILED DESCRIPTION OF THE INVENTION

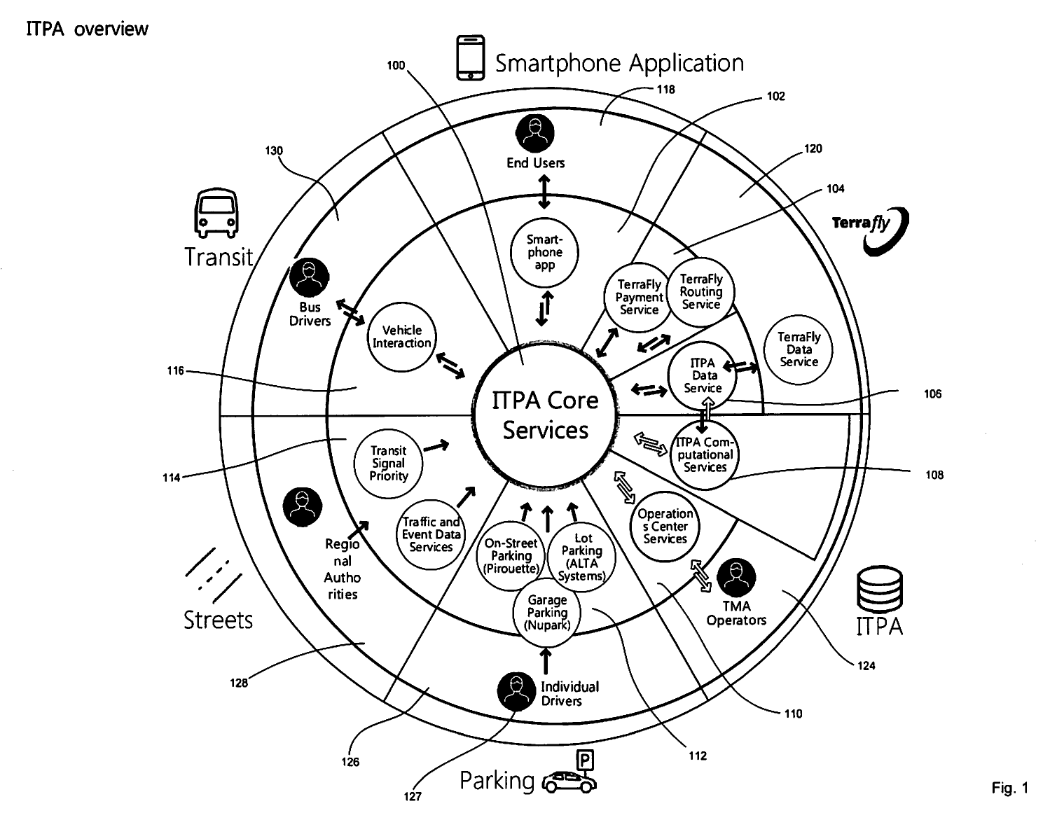

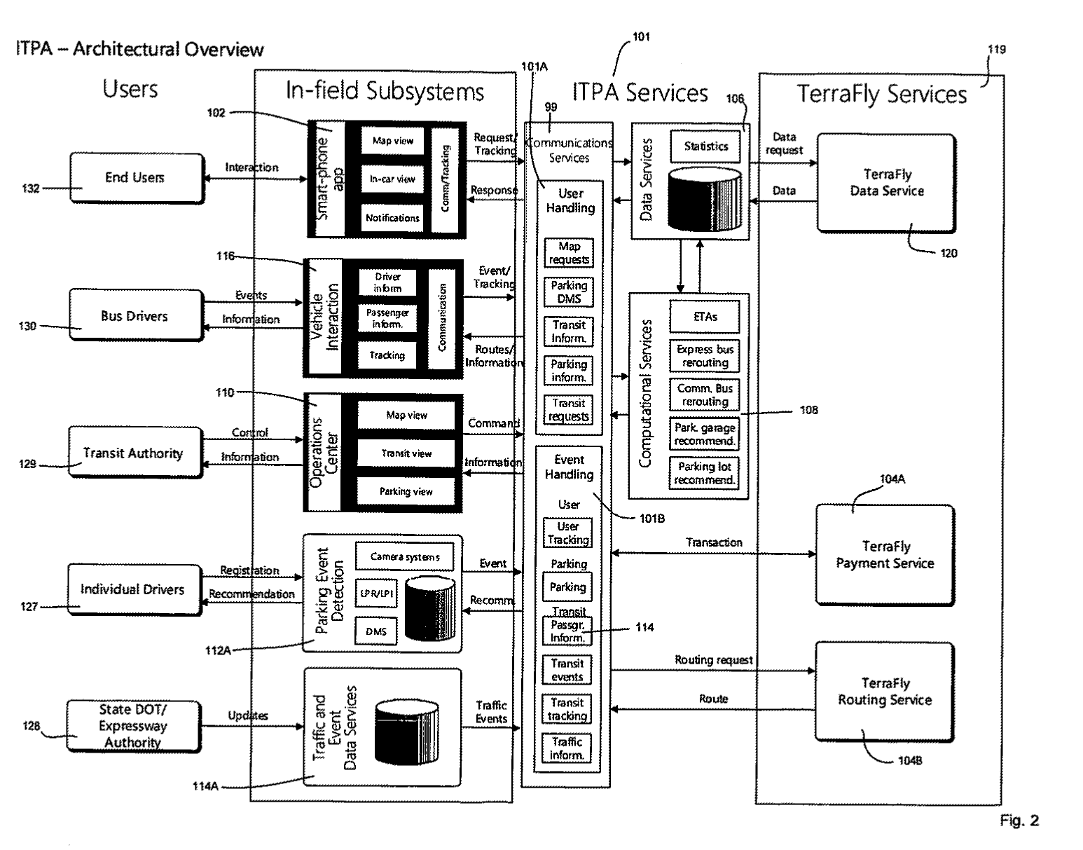

As may be seen in FIGS. 1 and 2, the present ITPA invention provides comprehensive real-time and predictive decision support in the areas of multi-modal and inter-modal transportation. It has two main objectives: to optimize local decision making by providing individual customers with all custom-tailored information on available multi-modal and inter-modal transportation options, and to optimize global traffic management by providing transportation service providers with management support to improve efficiency and effectiveness of their respective services, and to reach a new level of service by facilitating synchronized intermodal collaboration. An important ability and outcome of the present invention, system and method is enhanced situational awareness at a macro level, wherein large-scale transportation data management is achieved; through use of advanced knowledge and awareness of actual, historical and likely conditions along potential travel goal pathways and the capacity, through individual informed traveler decisions, to optimize transportation system capacities. Such “situational awareness” is the capability of a traveler to be aware of situations in time and space from multiple perspectives in order to determine the extent by which alternative travel trip choices will save time and expense and to be influenced to make more frequent multimodal and other transportation choices by taking away the mystery of price and scheduling tradeoffs, when shifting from one mode and path of travel to another.

Situational awareness when applied to travel may been seen as “a perception of elements in the environment within a volume of time and space, a proper factoring in of their relative impacts (particularly when aggregated in relation to an operator's goals), and their projected significance in the near future”. Transportation Data Management has been broadly defined as: “the application of strategies and policies to reduce travel demand, especially that of single-occupancy private vehicles, or to redistribute this demand in space and time.”

Many of these situations include everyday routine scenarios, such as rush hour traffic congestion and safety issues arising out of stop-and-go rush hour traffic as well as traffic congestion, and from specific anomalies, such as accidents, weather, public events such as sporting events, concerts, parades and processions, construction, government contingencies (i.e., security convoys for visiting dignitaries and the like), parking logjams, or commercial contingencies (e.g., special oversized passenger or freight movements).

A basis for advanced situational awareness and enhanced large-scale transportation data management is achieved through the use of historical traffic data and the development of best methods for data integration and analysis of the following statistical and situational data:

1. Detailed maps, routes and driving directions
2. Regional express bus, fixed-guideway transit, and train schedules (regional mass transit) between residential communities, universities, multimodal transportation centers, airports, seaports, major regional destinations, tourist hubs and job centers
3. Airline and waterborne transport schedules
4. Transportation capacities of common carriers providing services in, to, or from a region
5. Real-time location and actual and projected arrival/departure times for regional mass transit, airline, and waterborne transport
6. Real time traffic congestion information (rush hour or otherwise) on highways and arterials and on certain local streets that are determined by transportation system managers to be useful for regional travel as shortcuts or alternate routes as between highways as well as around frequently congested highway segments
7. Intermodal timing estimates for movements between specified locations on highways, arterials, and certain identified local streets, and the immediate access points for regional mass transit, airline, and waterborne transport
8. Smart parking garage information as to location of available parking spaces or reserved parking opportunities
9. Information that is confidentially retained by ITPA as to transportation preferences provided by the individuals who subscribe the ITPA service to help optimize the subscriber's trips
10. Information provided by ITPA sponsors who are featured as useful alternate business or other destination and broadcasted to ITPA users when needed to fulfill a travel requirement or need.

The above is shown conceptually in the non-technical overview of FIG. 1. Therein, it is noted that TERRAFLY is a registered trademark of NOA, Inc., Miami Beach, Fla., in regard to computer service for providing geo-spatial remote-sensing information and management via the internet and represents here an example of geospatial data management services platform upon which ITPA services are enabled.

As may be seen, ITPA core services 100 communicates with interior interfaces 102, 104, 106, 108, 110, 112, 114, and 116 in which:
102 is a smartphone application.
104 is a TerraFly routing and payment service.
106 is an ITPA data service.
108 are ITPA computational services.
110 are operation and center services.
112 are garage and parking related services.
114 are traffic, event data and transit signal priority data.
116 is a vehicle interface.

Each of the above, in turn, interfaces with outermost layers 118, 120, 122, 124, 126, 128 and 130 in which:
Layer 118 interfaces core services 100 to end users 118 such as smartphone users.
Layer 120 interfaces TerraFly routing and payment services 104 and data services 106.
Layer 122 interfaces to ITPA computational services 108.
Layer 124 interfaces TMA (Transit Management Association) and operation and center services 110 of ITPA.
Layer 126 interfaces individual drivers 127 to the parking options of interface 112.
127 are individual drivers in layer 126.
Layer 128 interfaces traffic event layer 114 to databases and communications of the state Department of Transportation and other transportation authorities, expressing the same in street or route specific terms.
Layer 130 interfaces vehicle layer 116 to bus drivers and other operators of public transportation.

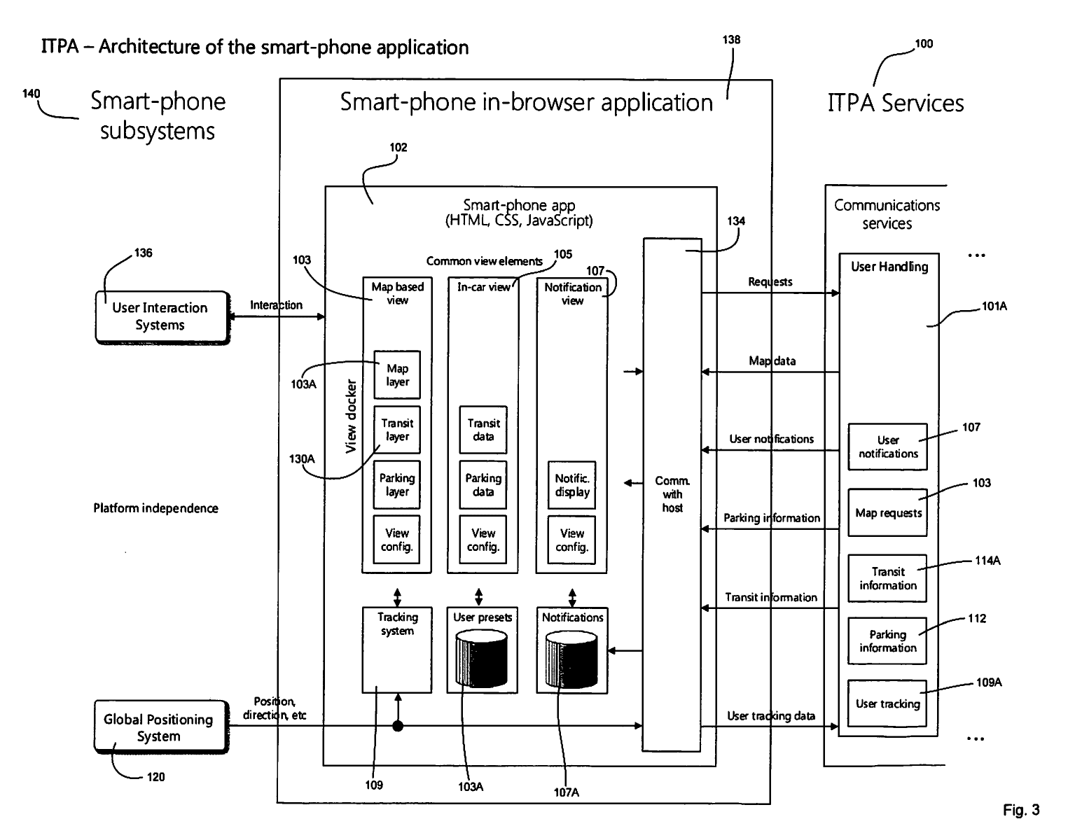

The implementation of the above may be more fully appreciated with reference to FIGS. 2 and 3, which, respectively, indicate an architectural overview of the ITPA system and the architecture of a smart phone application thereof. The term TerraFly as used herein refers to a geospatial data management system.

More specifically, FIG. 2 indicates the manner in which TerraFly Services 119, including TerraFly data services 120, referenced above, communicate GPS data. Further shown at the right of FIG. 2 is TerraFly payment service 104A, as applicable, and TerraFly Routing Services 104B.

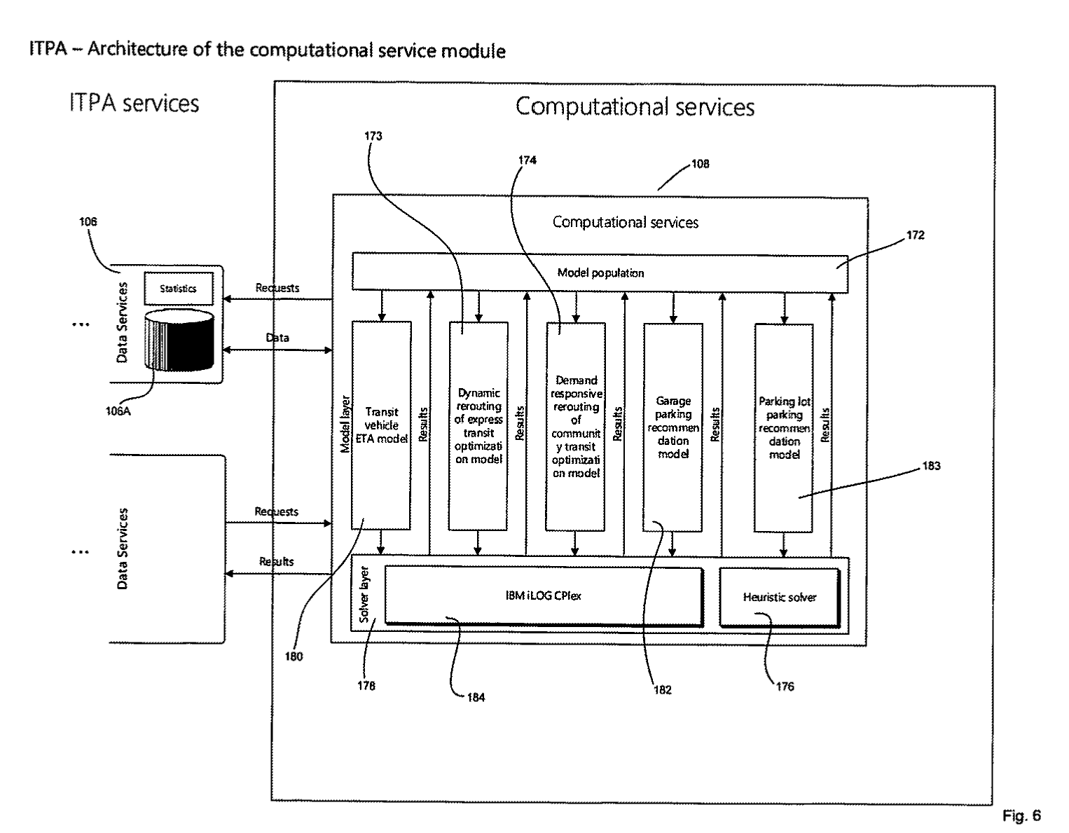

Moving to the left of TerraFly Services 119 in FIG. 2 are shown ITPA services 101 which include a plurality of components, namely, including communication services 99 which consist of user handling 101A and said event handling 101B. User handling services 101A includes map requests which derive from layers 106 and/or 114 of FIG. 1, parking information which derives from layer 112 of FIG. 1, transit information which derives from layer 114 of FIG. 1, parking information which derives from layer 116 of ITPA core services 100, and related information and requests. User handling services 101A are supported by the computational services 108 of the present system which includes a variety of capabilities inclusive of estimated arrival times 180, express bus re-routing 174, community bus re-routing, and parking recommendations 182. See FIG. 6.

All transportation and related data is updated at the most frequently possible intervals. This capability provides the system with the necessary information backbone to keep ITPA travelers current and informed and thus able to make intelligent decisions as follows.

With further reference to FIG. 2, travel suggestions, route-related recommendations and options are the key to proper operation of the system, based on identified traveler preferences. Such recommendations inform a traveler of options that may alter his or her plans. See FIGS. 3 and 6.=These suggestions are based on analyzing multiple situational awareness elements and may involve specific action related to departure times, a change in planned route, destination, or transportation modes for all or part of a trip. Examples include the following:
Delay travel for a specified period of time (e.g., leave in 10 minutes to avoid traffic congestion, or delay departure by 90 minutes to achieve the same result)
Reroute planned automobile travel (e.g., take local streets instead of a congested highway)
Take regional mass transit for part of or the entire route to the planned destination (i.e., highways are congested, but a specific regional mass transit option or options will bring the traveler to the same destination)
Select an alternate destination to achieve the same result (e.g., a different shopping center or a similar restaurant).

Further shown under ITPA services 101 in FIG. 2 are event handling services 101B, which includes user tracking by the GPS of service 120 of the system, parking information further to layer 112 above, transit passenger information 114, transit events also derived from layer 114 above, transit tracking and general traffic information, all of which services 101B are supported by TerraFly routing services 104B.

Moving to “In-field Subsystems” within FIG. 2, the same may be seen to include a Smart Phone application 102, a vehicle interaction module 116 and the Operations Center 110. Each of the smart phone application and the operations center provide map views of particular or general areas.

Smart phone app (see FIG. 3) particularly provides map-based views 103, in-car views 105, and notifications views 107, as well as tracking information 109. In regard to vehicle interaction module 116, there is provided driver information, passenger information, tracking information, a communication capability, and tracking and routing information with the ITPA user handling stack 101A. Vehicle module 116 in turn provides information to and receives information from bus drivers 130 and other operators of public transportation. Therein is shown Operations Center 110 (see also FIG. 1), which includes a map view, a transit view, and a parking view. Operations Center 110 is also able to communicate with the general ITPA service stack 101 with regard to demands for and receipt of information. The operations center may also provide information to a local or regional transit authority 129 and may also receive feedback therefrom.

Beneath Operations Center 110 is shown parking event detection module 112A, which includes camera systems, License Plate Recognition/License Plate Inventory (LRP/LPI), a data management system (DMS) and a database for recording information obtained therefrom. This information is available to all individual drivers 127 that subscribe to the present system. Therefrom individual drivers 127, after registration, may receive recommendations as to other routes or modes of travel which may result in savings of time, cost, or enhanced safety.

At the bottom center of FIG. 2 are shown traffic and data services 114A which maintain a database of relevant traffic events obtained from a state Department of Transportation and applicable expressway authorities 128. Outputs of data services 114A are provided to event handling stack 101B.

An example is to inform a traveler of a given planned route and current situational awareness information, for which a typical delay for automobile transportation along the planned route is 75 minutes while the delay for public transport is likely to be 15 minutes. If requested, ITPA could also estimate cost for each transportation option (i.e., cost to travel by private vehicle versus cost of regional mass transit and parking costs).

The system might recommend taking public transportation in this case, and provide information and routing guidance, which include various regional mass transit options (e.g., which trains, fixed-guideway transit or express buses to take and their likely departure time). This capability uses rules, analyses and predictive statistics (as well as heuristics and stochastics) to arrive at a recommendation. At first, travel suggestions would be limited the regional routes and destinations described in the situational awareness discussion above for which situational data is available. As the user base, database and historical archive grow, this would then make more choices available.

ITPA methodology involves routing instructions and guidance, including providing a traveler with alternative travel options and routing instructions based on their plans, on parking availability, and on situational awareness per CCTVs and other such inputs. For example, as ITPA anticipates congested roadways ahead, it would recommend alternative highways, arterial and street routes, identify locations of regional mass transit stations, and confirm ticket availability for boarding on such regional mass transit alternates. Importantly, when routing is requested, the system can also specifically include an analysis of available data concerning potential return trip conditions based upon time of day and reminder of any parking location used. The ITPA user will be given an opportunity at that time to make return trip plans and arrangements or to defer the decisions until later in the day. This provides users with more viable options; particularly in terms of the availability of regional mass transit (e.g., is regional mass transit available at the expected return time and what are the expected costs, including parking one's car in one location compared to another). If the recommended return trip is not desired by the ITPA user, a different return choice would be identified.

Routing guidance includes historical and predictive analyses of situational data for major routes when available. If neither real-time, nor historical, nor predictive data is available, then users are provided with, at the very least, turn-by-turn routing guidance similar to that available in standard GPS based navigation devices.

In FIG. 3 is shown the architecture of the system as applied to a smart phone 118 or smart phone application 102 (see FIG. 1). Also shown is a smart phone browser application 138, which includes a variety of capabilities inclusive of map based view 103, in-car views 105, selectable notifications 117, a tracking system 109, and user presets 115, which provide to the smart phone user a capability of receiving only information of selected interest. Notification database 107A operates in association with notification view 107 to create a historical record of notifications which have occurred. As may be seen on the right in FIG. 3, the above capabilities of the smart phone browser application 138 of necessity rely upon ITPA services 100 and, particularly, user handling stack 101A, the same inclusive of user notifications 107, map requests 103, transit information 114A, parking information 112, and user tracking 109. Interaction or communication between communication services 101A and smart phone browser 138 are controlled through communication layer 134. Subsystems 140 of the smart phone include user interaction systems 136 and GPS 120, by which position and direction of the system user are enabled in tracking system 109. As above noted, map based views 103 are supported by communication layer 134, which renders possible user tracking data and transit information 114 employed by user handling stack 101A, as referenced above.

FIG. 3 also illustrates the particulars of a Smartphone Application Architecture for the end-user which includes the smart-phone in-browser application interacting with the platform independent smart-phone subsystems, that are the interface to the user-input functionality of the phone and to its GPS module to report its (and the users) current position to the system, and also interacting with the communications services 101 of ITPA. The user's active and passive inputs to the app are what drive the communication and thus the output from the ITPA system, whether in the form of a route or advice, including transit and parking information, event notifications, and the like.

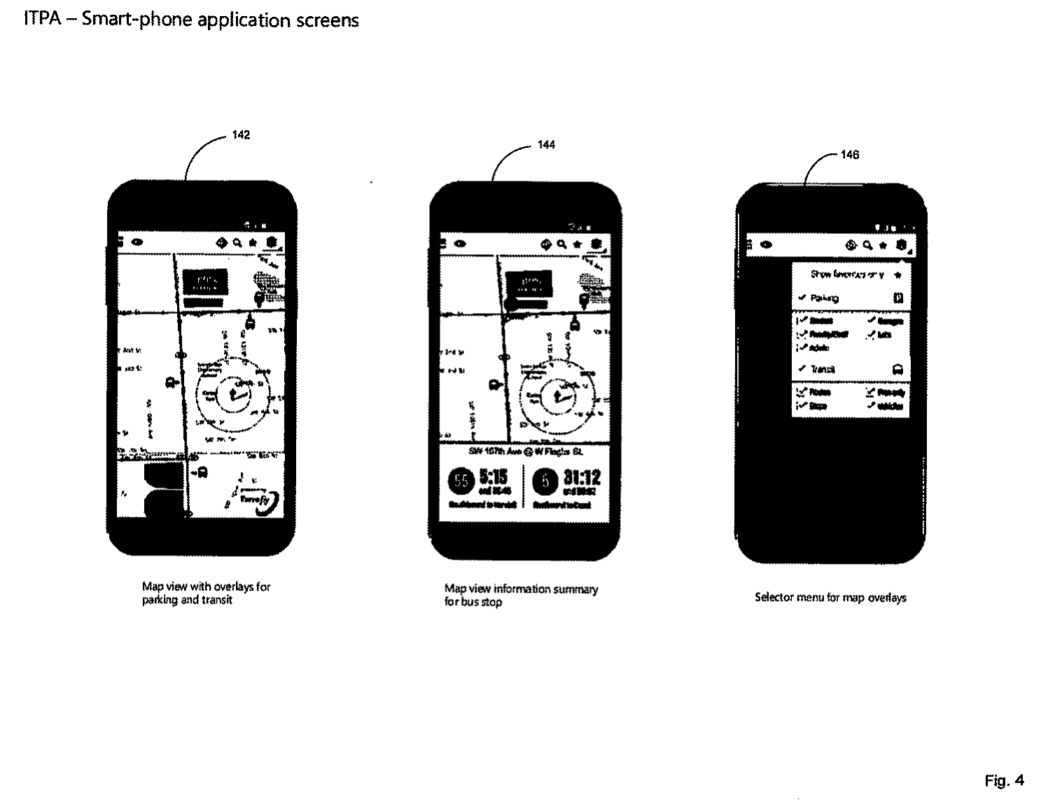

In FIG. 4 are three examples of smart phone application screens illustrating some of the above-referenced capabilities of the system. More particularly, screen 142 of FIG. 4 is a map view over-overlay which show parking and transit options. The screen 144 of FIG. 4 is map view information summary for use at a bus stop. Third screen 146 of FIG. 4 is a menu by which one may select a desired map overlay.

### Technology and Global Architecture

ITPA focuses on advanced real-time and predictive analytics rather than extensive in-situ hardware and sensor systems, although some of these are necessarily part of the system. It utilizes both crowd-sourced data, e.g. data collected by smart-phone apps, as well publicly available data, e.g. from toll and traffic monitoring stations, or directly on board transit-vehicles. Without dedicated sensors at its disposal, ITPA often does not have exact information but reaches high rates of accuracy by utilizing geospatial data-mining technologies, combined with agent-based traffic modeling and simulation, and using problem-solving algorithms, as well as combinatorial heuristics such as genetic algorithms and ant-colony optimization.

ITPA consists of several key elements as above noted:

The smart-phone app 138 (see FIG. 3) allows users to request information (real-time and predictive) on traffic conditions and inter-modal transportation options, to reserve and pay for parking and seats on express transit, to buy tickets for events and to request transit for the demand responsive community transit system.

The computational server 108 (see FIG. 6) hosts the heavy-duty simulation and optimization modules which would otherwise hinder a low-latency response, e.g. for demand responsive community transit and conditional express transit rerouting, and predictive user behavior, traffic and parking pattern analysis.

The routing server 104B enables inter-modal routing and recommendations, e.g. considering pedestrian and car traffic (including parking recommendations), taxi cabs, express and community transit, short-term car and bicycle rentals, and serves as a bridge to other participating transportation service companies, as well as planning authorities.

The database server 106 administers an extensive database of historical traffic data, updated in real-time from smart-phones, vehicle interaction modules and public data sources. It also stores a history of predictions, thus allowing for further validation and improvements of the predictive models.

The communications server 99 (see FIG. 2) serves as a bridge between user devices and the other ITPA components, guaranteeing a low-latency response. It attends to user requests and demands corresponding services from the database, computational and routing servers.

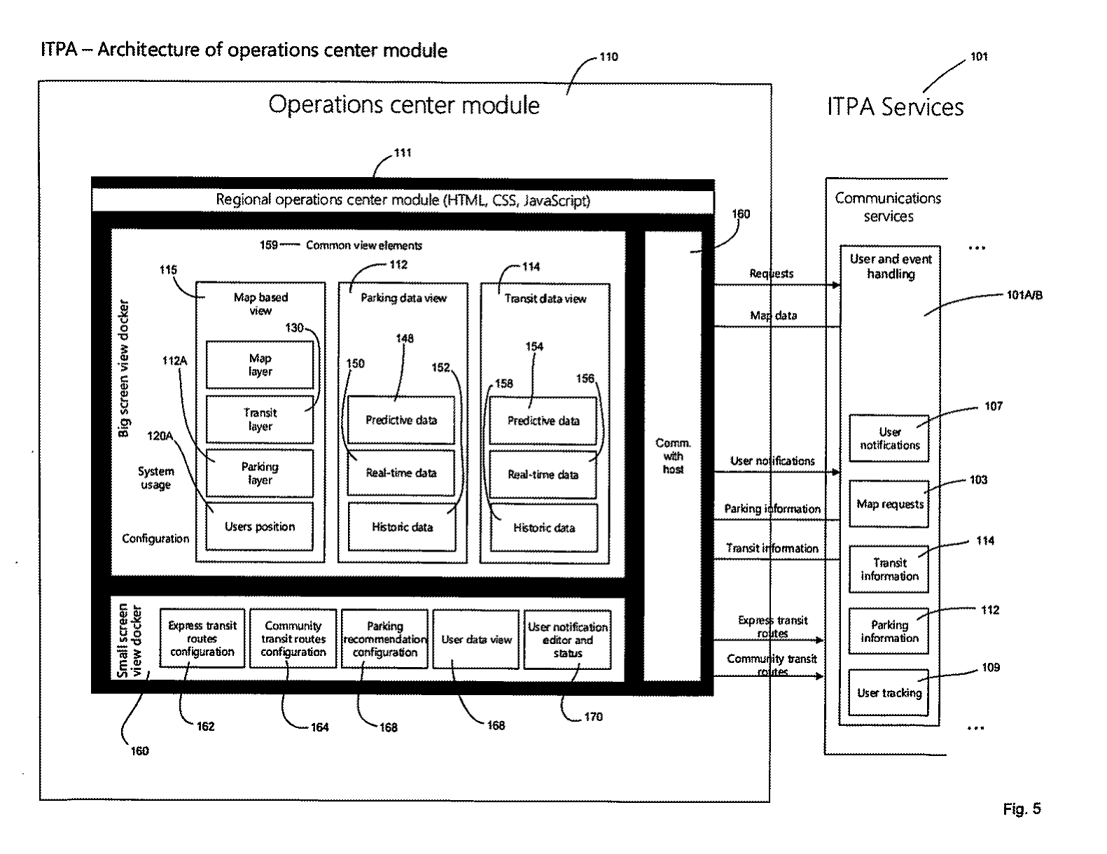

The operations center module 110 (see FIG. 5) provides an overview of the (real-time and predictive) state of the transportation system, and provides detailed decision support for transportation planning and operations. It is intended for use by the regional transit authority and other planning entities.

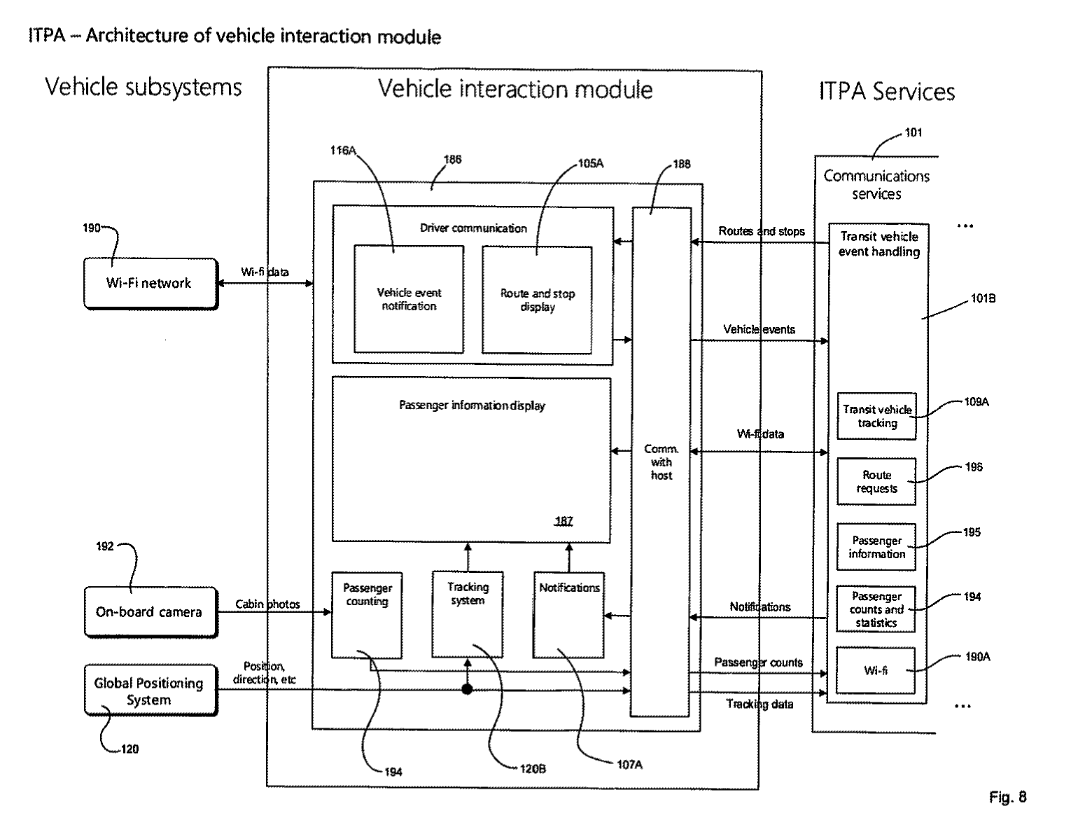

The vehicle interaction modules (see FIG. 8 described below) consists of two-way communications hardware on board the transit vehicles. They include GPS trackers, 120B tablet computers installed next to the drivers' seats, camera systems, and passenger information displays 187. They communicate via the cell-phone network with the communications server 99, transmitting the vehicles' position, number of passengers and special events notifications 116A, dynamic routing information 105A and passenger 194 information (e.g. estimated times of arrival and kept or missed connections). They may also provide a Wi-Fi service 190 for passengers.

To create the innovative ITPA system and software, existing intelligent transportation component assets already in use in “smart cities” around the world are combined with intelligent transportation and business analytics, spatial analytics, and other intelligent components as suggested by the ITPA non-technical architecture overview shown in FIG. 1. Thus, already computerized bus and rail subsystems, smart parking garages, traffic light control systems, toll booth and smartpass systems, street view cameras, and other infrastructure may be phased in to communicate with the ITPA interface and a smart GPS-mapping, routing, and traffic intelligence service (or a geospatial data management system) through the central ITPA core services module 100, to provide inputs to the Computational and Analytic Modules of ITPA and then the processed data is pushed upstream to a smartphone application.

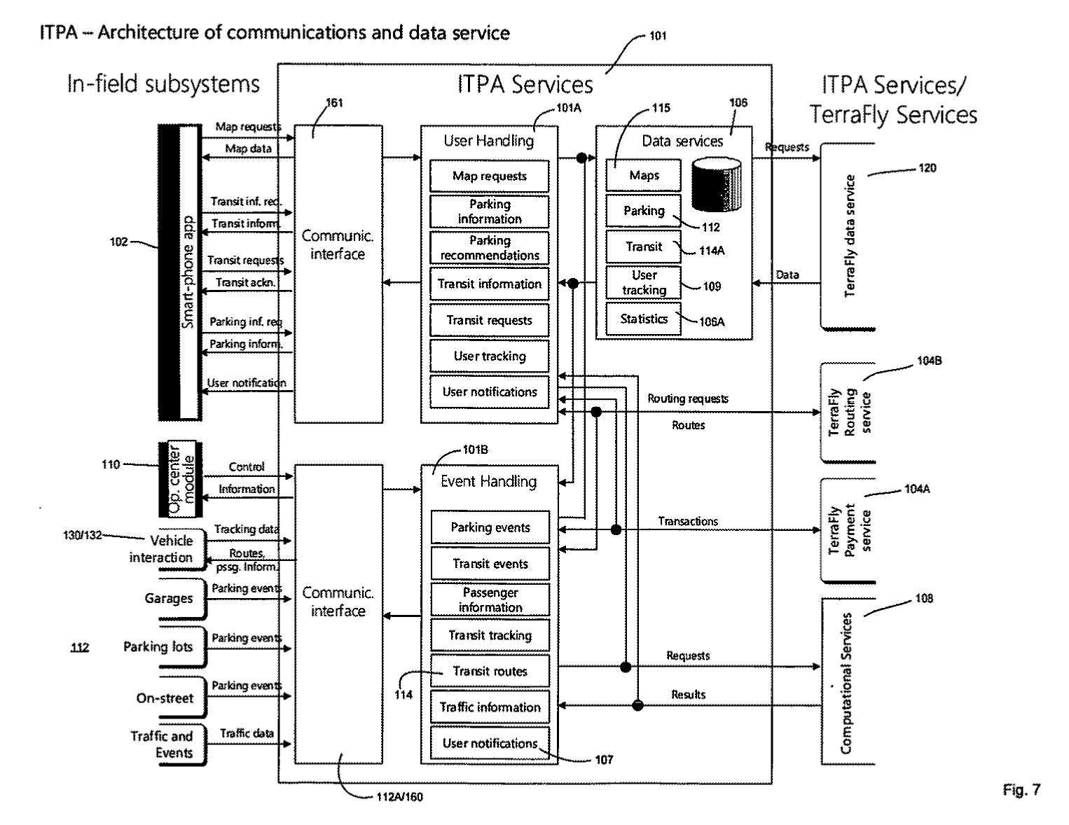

FIGS. 2 and 7 provide a high-level overview of the ITPA system's interaction in which the various types of users access the ITPA system and its composite information and data repository through their respective appropriate interfaces to the ITPA service layer 101 i.e., through respective so-called in-field subsystems; individual end users, i.e. pedestrians or commuters through their Individual smart-phone applications, bus drivers through their partly embedded vehicle interaction modules, each transit authority through its operations center, individual drivers seeking parking at an end destination through the parking event detection module, and each state's Department of Transportation or each expressway authority through its traffic and event data notification service component. Individual signals in the form of tracking inquiries, commands, and event logging etc. constitute the various inputs relative to the system which result in either an update to the ITPA database or a query which results in a recommendation or in resultant data. Events may include traffic density/clogging, accidents, extreme weather conditions, unexpected emergencies as well as pre-planned community events. Historic trends and archival data are used to tweak the system and add predictive functionality as a further input. Other inputs include the need for and availability of parking. The ITPA service layer 101 also handles each kind of user enumerated as well as each form of Event that is logged as an input to the system. Data services include updating and querying from the archival database as well as the overlay of the mapping and routing data. Computational services 108 comprise calculating an optimized route with an expected time of arrival 180, as well as suggested parking opportunities in the region of the final destination. An example of a geospatial data management system or a smart GPS-mapping, routing, and traffic intelligence service, is the TerraFly™ system, which is a repository for both ‘dumb’ data, such as geospatial mapping data, and also has a smart routing functionality. FIG. 7 further expands on the request-driven communication and data processing between the modules. Some individual modules are laid out below.

FIG. 5 shows how the operations center module 110 interacts with ITPA Services 100 in the form of a regional operations center module, which can take the form of a large control panel terminal. Key elements of the display are the map view 115 upon which are overlaid the parking and transit possibilities, which both can be then expressed in formatted results for planners and troubleshooters. Subsets of these two key data elements can be viewed in a smaller screen module along with configuration, notification presets and preferences as well as a user view. Communication with ITPA follows in the form of requests, notifications, return of relevant information such as parking and transit possibilities and optimized routing options.

Within a common view elements screen 159 are said map based view 115 having a map layer 103A, transit layer 130, parking layer 112A and a user's GPS position 120A.

Within the parking data view 112 of the regional operations center module 111 is predictive data 148, real time data 150 and historic data 152. Within transit data view 114 is predictive data 154, real time data 156 and historic data 158. Module 111 interfaces with ITPA communication services 101A/101B through communications buss 160 of operations module 111. Therebetween are provided an exchange of a variety of information inclusive of requests, map data, user notifications, parking information, transit information, express transit routes and community transit routes.

Beneath the common view elements screen 159 of regional center module 111 is a smaller screen 160, above referenced, upon which one may selectably observe or modify express transit routes and configurations 162, community transit routes and configurations 164, parking recommendations and configurations 166, user data views 168, and user notifications 170 of edits and status to the common view elements screen 159.

FIG. 6 shows how the computational center service module 108 functions in response to ITPA forwarded requests from a user or other module to produce a resultant set of static or dynamic data. Whereas the ITPA paradigm is based on crowdsourcing, archival behavioral data and heuristics, queries are solved based on a model population 172, which model itself may be dynamic, and which is constantly tweaked with each new system iteration. An express transit optimization model 173 responds to the immediate and expedient needs of a single commuter/user, whereas a community transit optimization model 174 is more demand-based, including adjusting each vehicle's route, based on the needs of an entire class of system users, taking into account optimal distribution of commuters. Depending on which model is presently used, the heuristic solver 176 of a solver module 178 are accordingly adjusted, and the optimized route calculated. Similarly, a single driver using a private vehicle combined with transit uses the transit vehicle ETA (estimated time of arrival) model 180 to ensure optimization of time and route as well as a possible schedule management to properly adjust all activities to be undertaken within the trip. There is a necessary level of flexibility required on the user's part to fully utilize the advantages of this model. Similarly, parking-driven modules 182/183 take best account of all parking opportunities proximate to either a final destination or a transition point from vehicle to public transit. IBM iLOG CPlex 184 is an example of a decisional platform which can serve the system, though any distributed computing architecture having decisional and predictive capability, properly scaled.

The following snippets of pseudocode illustrate the operation a heuristic algorithm (morning-advice), with predictive models and rule-based constraints to all potential routes with potential intermodal transfer points, using real-time and historic data available to compute an optimal route and mode of transportation; and an optimization algorithm (navigate) by time, cost, duration and safety, to further narrow down options point-by-point along the route. The snippet syntax should be taken as generic and self-explanatory:

Pseudocode function morning-advice (customer, timestamp, customer-coordinates,
destination) {
If customer-coordinates==null then customer-coordinates := home-
coordinates(customer)
If destination==null then destination := work-coordinates(customer)
If destination !~ [latitude, longitude] then geocode (destination)
Preferences := Preference-DB[customer]
Customer-history := History-DB[customer]
(driving-path-now, driving-time-now, commute-quality-estimate-drive-now) := Routing-
Modeler(customer-coordinates, destination, road network, crowdsourced realtime traffic
in each available road segment, authoritative real time road congestion data in each
available road segment, Historical traffic in each available road segment)
(park-n-ride-path-now, park-n-ride-time-now, commute-quality-estimate-ride-now) :=
Routing-Modeler(customer-coordinates, destination, road network, crowdsourced
realtime traffic model, authoritative real time road model data, Historical traffic model,
transit schedules, transit real time data, Customer-history)
(driving-path-delayed, driving-time-delayed, time-to-commence-drive, commute-quality-
estimate-drive-delayed) := Routing-Modeler(customer-coordinates, destination, road
network, crowdsourced realtime traffic in each available road segment, authoritative real
time road congestion data in each available road segment, Historical traffic in each
available road segment)
(park-n-ride-path-delayed, park-n-ride-time-delayed, time-to-commence-travel,
commute-quality-estimate-ride-delayed) := Routing-Modeler(customer-coordinates,
destination, road network, crowdsourced realtime traffic model, authoritative real time
road model data, Historical traffic model, transit schedules, transit real time data,
Customer-history)
Display to user: driving-time-now, commute-quality-estimate-drive-now, driving-time-
delayed, time-to-commence-drive, commute-quality-estimate-drive-delayed, park-n-ride-
time-delayed, time-to-commence-travel, commute-quality-estimate-ride-delayed
Obtain user choice
Advise of path and parameters
Offer parking reservation
Effect parking reservation}
Pseudocode function navigate (customer, destination, modality, route-plan, previous-
ETA, previous-accepted-ETA) {
While true do {

Wait 1 second
Current-location := GPS(customer)
(new-route-plan, new-ETA) := Routing-Modeler(current-location, modality,

destination, road network, crowdsourced realtime traffic in each available road segment,
authoritative real time road congestion data in each available road segment, Historical
traffic in each available road segment)

If (ETA>Previous-ETA + 0.5 minute) then {route-plan:-new-route-plan}
If (ETA>Previous-accepted-ETA + 10 minutes & modality==’car’) then {

alternative-modality=’park-n-ride’;
(park-n-ride-plan, commute-quality-estimate-ride, ETA-transit) := Routing-

Modeler(current-location, destination, alternative-modality ,road network,
crowdsourced realtime traffic model, authoritative real time road model data,
Historical traffic model, transit schedules, transit real time data, Customer-
history)
If (ETA-transit +10 minutes< Previous-accepted-ETA) {

display to user: ETA, ETA-transit, commute-quality-estimate-ride, park-n-

ride-path

prompt for user decision
if user accepts then {

ETA:=ETA-transit;
route-plan:= park-n-ride-plan;
}

Previous-accepted-ETA:=ETA}

display-directions(current-location, route-plan)}

}
}

Shown in FIG. 7, is the architecture of the communications and in data service functions of ITPA. More particularly, beginning on the right of FIG. 7 are shown TerraFly data services 120, TerraFly routing service 104B, TerraFly payment service 104A and computational services 108 (see FIG. 6).

Moving to the left of TerryFly data services 120 are a breakout of the specific data services 106 employed in the present system, namely, maps 115, parking 112, transit routes 114A, user tracking 109, and statistics 106A. Therefrom data flow proceeds to ITPA services 101 and, specifically, to user handling 101A, which, as may be noted, includes map requests, parking information, parking recommendations, transit information, transit requests, user tracking and user notifications. Therefrom data flows to a communications interface 161 and therefrom to smart phone application 102. Between interface 161 and smart phone app are data exchanges relative to maps, transit information, transit requests, parking information, and user notifications. Beneath user handling functions 101A are shown event handling functions 101B, namely, parking events, transit events, passenger information, transit tracking, transit routes 114, traffic information and user notifications 107. These in turn are fed to a communications interface 112A/160, above described in FIGS. 2 and 5. To the left of communications interface 112A/160 is operations center module 110, above described with reference to FIG. 5. Therefrom, control of communications interface 112A/160 is effected and, as well, information is received therefrom. Below 110 are provided in-field subsystems relative to vehicle interactions 130/132 in respect to tracking data and routes for consideration by a system user and, therebelow, various garage and parking information 112 which is provided to said communication interface 112A/160.

As depicted in FIG. 8, a vehicle interaction module 186 of ITPA controls the largely automated interaction between vehicle subsystems, vehicle interaction module and ITPA services, to handle passenger counting 194, a tracking system 120B, and production of notifications 107A to maintain and display information about a given transit vehicle on screen 187. All events are handled through the automated transit vehicle event handler 101B of the communication module 120. Aspects such as passenger counts and statistics 194, passenger information (to the level desired and available) 195, route requests 196 (including requested stops) are all part of the tracking system 120B, and include GPS coordinates 120, time and direction as part of an overall data record as well as an on-board camera 192. Necessary local components within a vehicle are linked by an onboard Wi-Fi network 190/190A. Vehicle interaction module 186 includes a vehicle event notification display 116A and route and stop display 105A, Buss 188 communicate with the ITPA hosts 120.

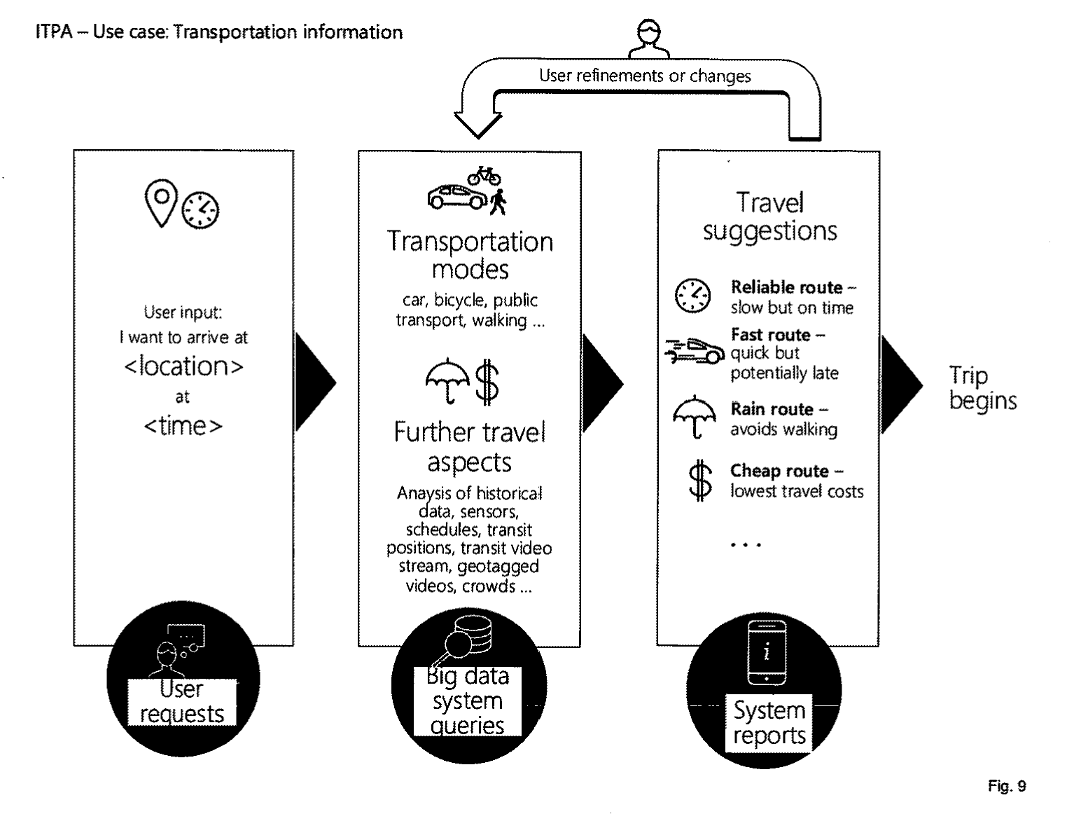

In regard to FIG. 9, there is shown a summary of the functions of the present system from the perspective of a user. More particularly, to the left thereof is shown user input in terms of location and time. Such input is followed by transportation modes as well as an analysis of historic data, sensors, schedules, transit positions, transit video streams, geo-tagged videos and crowdsources information from which such large data system is able to respond to queries of the system user and therefrom to make travel suggestions which are indicated on the right of FIG. 9. These travel suggestions will typically fall into five categories, namely, most reliable route, fastest route, rain route (which avoids outdoor walking), cheapest route, and safest route (not shown in FIG. 9). Thereupon, the user may choose to find his choice of transportation mode shown at the middle of FIG. 9. After the user has determined the transportation mode and travel suggestion route of preference, the trip will begin and the same will be reported to operation center module 110.

The overall aim, regardless of the model and paradigm being used is to reduce overall time and expense of trips, both to the individual driver as well as to the transit system, and to maximize and optimize usage of the transit system where possible. Routes are calculated with these aims in mind. A combination of heuristic and analytic algorithms may be used as well as a variety of hardware architectures.

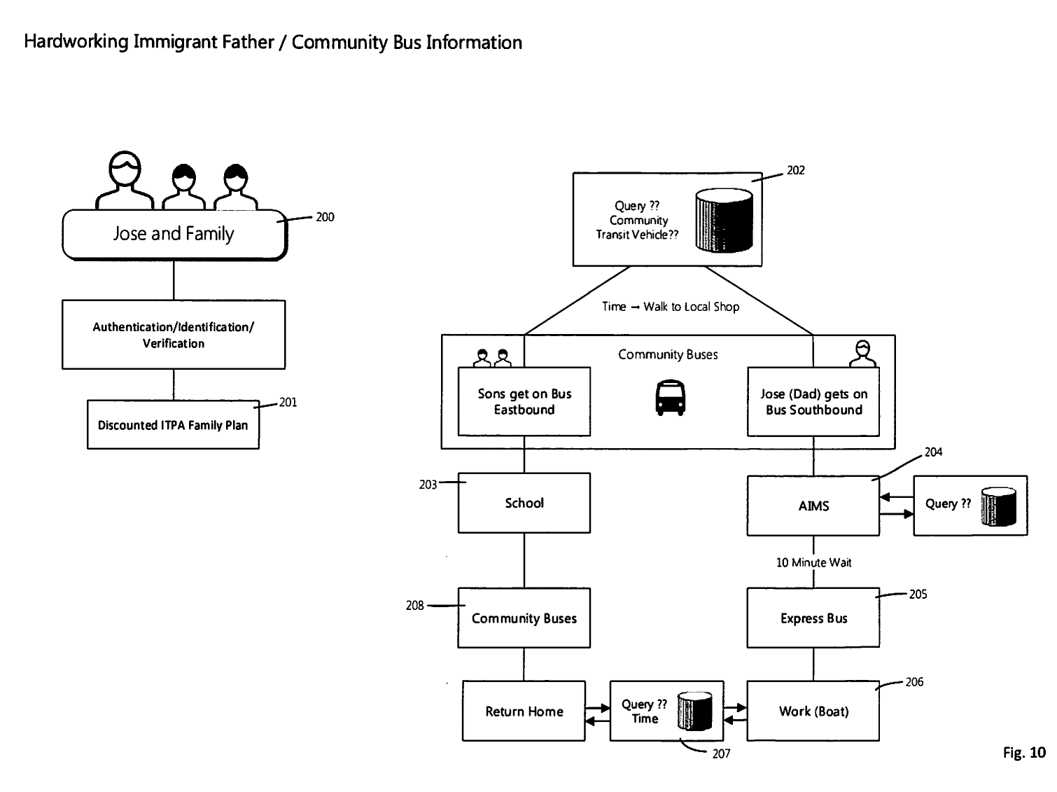

Shown in FIG. 10 is an example, in flowchart form, of the use of the above ITPA system where only community buses, express buses and other public ground transit vehicles are employed. In this example, a hardworking immigrant father 200, referred to above in the Background of the Invention and his sons 200 decide to employ the ITPA system commuting purposes, to go to work 206 in the case of Jose, and to school 203 in the case of his sons. However, as is noted at the left of FIG. 10, each ITPA user must first pass through an authentication/identification/verification process. Thereafter, Jose and his boys are advised if they will qualify for a discounted family plan, student plan, or low income plan offered or subsidized by the community. Thereafter, in the manner indicated at the left of FIG. 9, and in block 202 of FIG. 10, each user will query ITPA services 101 relative to the availability of University or TMA community transit vehicles, which query and response is indicated by the lines below block 202. Community service requests 101A (FIGS. 2 and 7) provide to Jose and his sons two basic answers, that is, the time required for the boys to walk to a suitable bus stop and, for Jose, the time needed to walk to a local or community bus stop for the transit strategy suggested by ITPA services 101A. With respect to the sons, as may be noted at the left branch of the flow diagram from block 202, the sons will embark upon suitable community buses to their destination, one upon the E bus and the other upon the E bus, or both may take the same bus. Their respective school locations are reflected in block 203 and, therefrom, after school classes, they will again embark upon community buses 208 to return home. In the case of Jose, after walking to a local bus stop, he will take either the B bus or the S and then will arrive at a central transportation hub 204 denoted as FIU AIMS. At that point, he may further query the ITPA system in regard to the next segment of his trip, the answer being that he should wait ten minutes and take the express bus (indicted by block 205) which in turn will take him to his work site 206 which is at a boat or marine craft in the port area of the community. The time required for the trip home for each Jose and his boys may be ascertained from ITPA data services 106 (see FIGS. 2 and 7), this indicated by block 207 in FIG. 10.

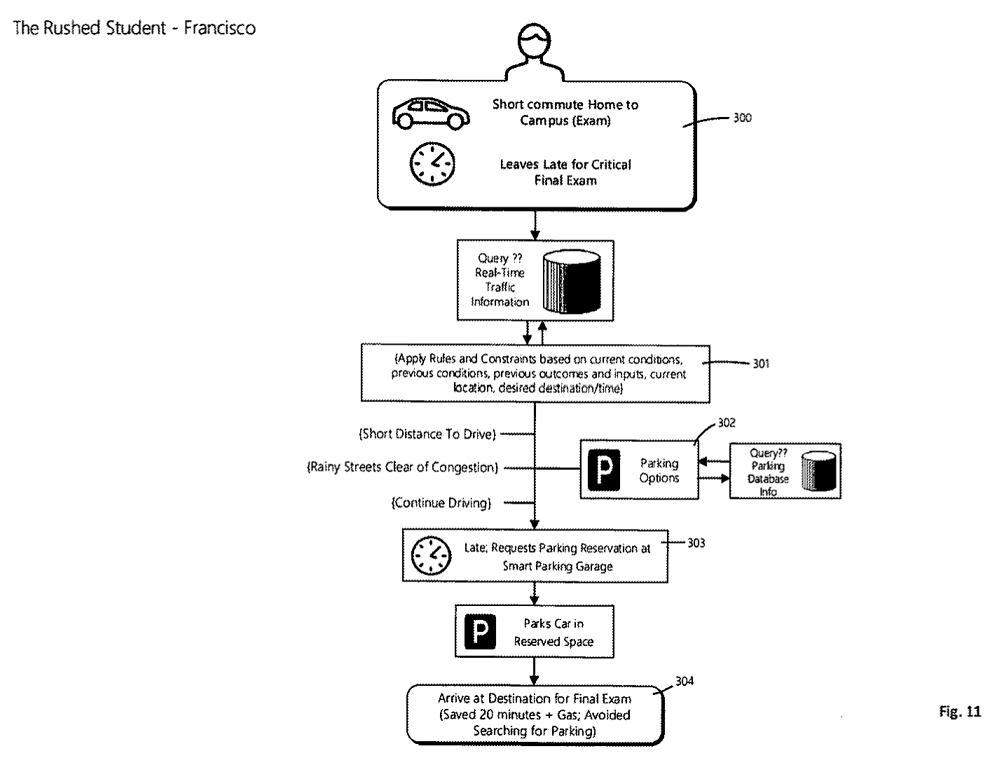

In regard to FIG. 11, there is shown a flow chart reflecting a typical use of ITPA by a student and, typically, one who intends to commute to school to take a final exam at a college he is attending, this as also referenced in the Background of the Invention above. Block 300 of FIG. 11 indicates that the student Francisco is located a short commute from his home to his college campus but leaves late for a critical final exam. Therefore, he queries user handling services capability 101A of ITPA system to request real-time traffic information if he were to take his normal route to the campus. Computational services 108 of the present system are supported by data services 106 and solver layer 178 of the system (see FIGS. 2, 5, and 6) will, as is shown at block 301, apply rules and constraints based on current conditions, previous conditions, previous outcomes and inputs, current location and desired destination/time to advise Francisco in regard to travel suggestions in a nature shown at the right of FIG. 9. These include, as may be noted in FIG. 9, shortest distance to drive, the best route given rain conditions, cheapest route, the most reliable route, one of which will be customary route to campus. Should he be advised that, due to rain conditions or other conditions likely to cause congestion, he may consider parking options 302 that drawn upon the parking information capability of user handling module 101A, using data passing through communications interface 161 and to his Smart Phone application 102. See FIG. 7. Parking options are viewed at block 302. Thereupon, Francisco may submit/request a parking reservation at smart parking garage, as noted at step 303 of FIG. 11. This information may be observed by Francisco through his in car view 105 of his university smart phone application 102 as is shown in FIG. 3. Upon arrival, he will then park his car in his reserved space and arrive at his destination to take his final exam, this as indicated at block 304. Thereby, he has saved 20 minutes, saved gas, and avoided searching for a parking space at his school.

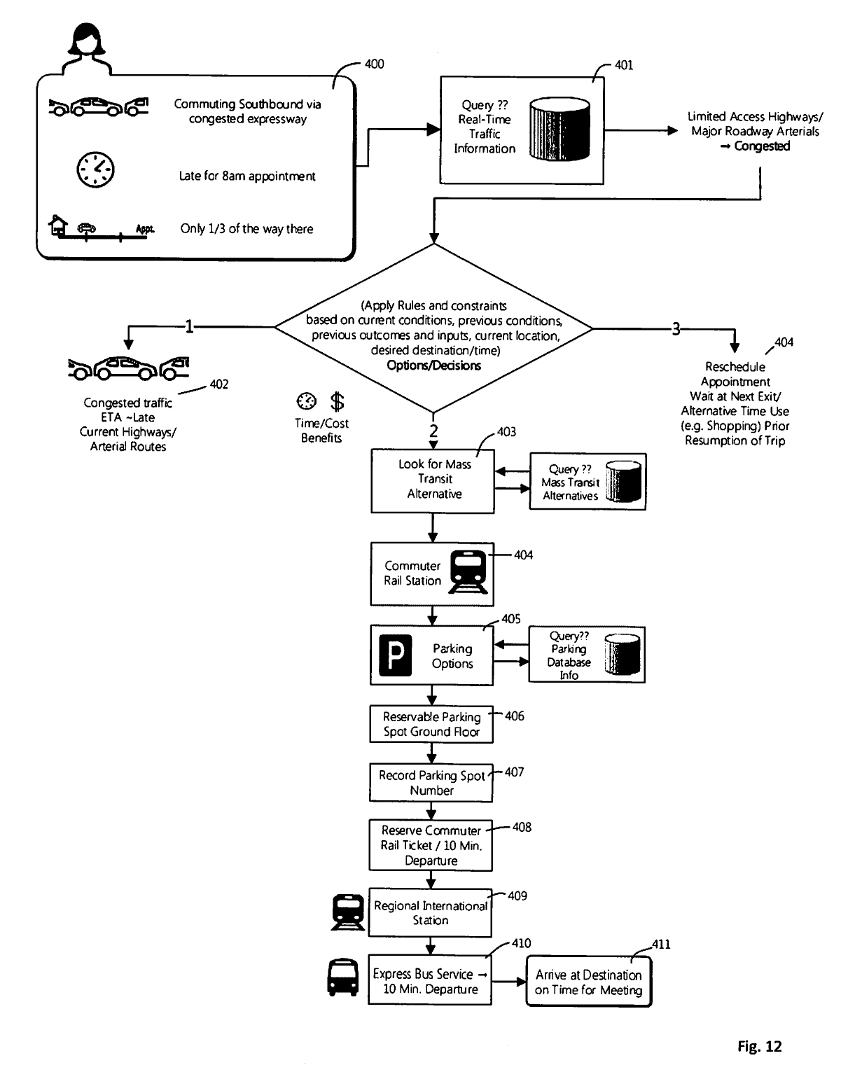

In regard to FIG. 12, there is shown in flowchart form integrated usages of a private vehicle and public rail transit in the ITPA system. In this example, a female user of the system wishes to communicate from northern Broward County, Florida, using Interstate 90 (which happens to be congested) to eventually arrive at her destination in Miami, Fla. As indicated in block 400, she is already late for an 8:00 a.m. appointment and only one-third of the way to her destination when she realizes the situation. Thereupon, using a cell phone equipped with the ITPA smart phone application shown in FIG. 3, she will query user handling services 101A to obtain transit information 114A as shown at the right of FIG. 3. With this information, she is advised of the limited access highways and major roadway arterials between her location and Miami, all of which are congested at that time. At that point, her ITPA application will access solver layer 178 of computational services 108 (see FIG. 6) of the present system will take into account system rules and constraints based on current conditions, previous conditions, previous outcomes and inputs, current location, desired destination and time of arrival. In other words, solver layer 178 will provide to the ITPA app user her three options, namely, Option 1, Option 2, and Option 3, which are shown as arrows from diamond 178 in FIG. 12. Option 1 is continue in congested traffic, as indicated by reference numeral 402, wherein she will be advised of her estimated time of arrival and real time road conditions as well as arterial routes that may be considered.

Option 3 as may be noted, consists of the rescheduling of her appointment, noted by block 404 and thereupon using such additional time to exit the interstate and use the generated time for other purposes, such as shopping, before resuming her trip, so that she may arrive at a proper time at the rescheduled appointment.

Option 2, as indicted in FIG. 12, is that of looking for a mass transit alternative, indicated by block 403. Therein, the driver will query mass transit alternatives using transit information block 114A shown at the right of FIG. 3. If an acceptable mass transit alternative is located, she will board a local community rail station at, in the example of block 404, the Sheridan Street stop of what, in South Florida, is termed the Tri-Rail system. At this point she may elect to board the Tri-Rail, however, before doing so, will determine her parking options 405 at that stop also indicted at block 112 of FIG. 3 and, therewith, determine parking availability as a part of her decision-making process. This determination of whether she can reserve a parking space on the ground floor of the parking garage of interest, is indicated by block 406 and a record of the reserved parking spot number is kept by her system and her ITPA cell phone app as indicated by block 407. Concurrently, she may reserve a Tri-Rail Ticket for a train scheduled to depart in ten minutes as indicated by block 408. If that option is taken, the user will embark upon Tri-Rail and continue until the Miami International Center Stop indicated by block 409 and thereform board a University express bus 410 which entails a trip of 10 minutes and arrive for her meeting at the University as indicated by block 411.

As may be seen from the above at block 407 the driver must make a decision whether to park her vehicle at an available parking space at the auto vehicle garage of the Sheridan Tri-Rail Station and then board the Tri-Rail within 10 minutes thereafter, to continue in the congested traffic conditions (Option 1), or to re-schedule her appointment as indicated by Option 3 and at the right of FIG. 12. In other words, it is the driver's decision, of whether she is able to reach the Tri-Rail Station, park her car and reach the departure platform, all within 10 minutes. If she decides that she can do so, then the hybrid private vehicle/public transit Option 2 will be taken or perhaps shifting to an arterial route of Option 1, or may reschedule her appointment (Option 3), using the created alternative time either for personal chores or to park her car at a more leisurely rate and simply take the next available train from the Sheridan Street Tri-Rail Station.

Nothing in this disclosure or claims should be construed as limiting the scope of implementation of the present invention, but merely as exemplary embodiments thereof.

1-10. (canceled)

11. A system for routing a commuter's travel to a defined destination, the system comprising at least one in-vehicle monitoring device, at least one processor, at least one memory, and at least one digital storage medium, the at least one digital storage medium comprising a geospatial real-time database and program instructions stored thereon, the program instructions comprising the following modules:
(a) a smartphone application module to provide an individual interface and user-input functionality of a smartphone to a user thereof, and to provide mode options and trip scheduling and to allow a GPS module of the smartphone to report a current position to the system;
(b) a bidirectional on-board vehicle interaction module with local components linked by a Wi-Fi network, to inform a public transit system operator and a transit authority operator conditions of individual transportation vehicles within the public transit system and overall conditions of the public transit system, and to keep track of passenger count statistics, passenger information, route requests, ticket or space availability, and UPS-coordinates;
(c) a transit authority operations center module with a large control panel to monitor parking and transit possibilities within the public transit system, providing both a macro-level map view upon which are overlaid various parking and transit possibilities, and a smaller screen module having configurations, notification presets, preferences, and a user view;
(d) a parking-event detection module to aid a user in seeking parking at a defined destination or at transition points to another mode of transport using real time data of parking possibilities, from an aggregation of parking authorities overseeing parking meters, street parking, and parking garages;
(e) a traffic and event data notification service module for a transit authority to keep track of real time data and historical data, choice of mode of transport, and trip schedules along each potential route from the geospatial real-time database, and to communicate these to a user and to an operator of the transit system, the real time data and historical data comprising events, occurrences, and trends affecting traffic;
(f) a data services module that updates and queries the real time data from a real time database comprising events, occurrences, and trends affecting traffic, as well as choice of mode of transport and trip schedules along each potential route, from the geospatial real-time database overlaying mapping and routing data, the data services module also updating and querying the historical data from an archival database;
(g) a computational services module comprising a solver layer that calculates an optimized route for a user, with an expected time of arrival at the user's defined destination, as well as suggested parking opportunities proximate to the user's defined destination; and
(h) a communications layer module relaying requests, queries, tracking events, and results between modules (a)-(g).

12. The system according to claim 11, wherein the solver layer of the computational services module:
applies a heuristic algorithm, with predictive models and rule-based constraints, to all potential routes with their potential intermodal transfer points, using the real-time and history data available to compute an optimal traffic route and mode of transportation at the present time and providing informed suggestions to the user of a plurality of optimal traffic routes, modes, and trip schedules in accordance therewith;
then applies an optimization algorithm by time, cost, duration, and safety, to further find the best potential routes for the user to choose, taking into account user preferences; and
then allows the user an opportunity to pick one of the plurality of optimal routes or modes, as well as a departure time, to reduce time and cost of travel, while considering weather and safety.

13. The system according to claim 12, wherein the optimization algorithm furthers the goals of the transit authority to reduce personal vehicle and traffic density, and to maximize and distribute use of public transportation system components by dispersal over available routes, modes, and trip times.

14. The system according to claim 11, wherein the parking-event detection module:
enables the user to reserve a parking space within a parking garage or a dedicated parking zone for a selected time period; and
provides a notification to the multi-modal transportation system, that the parking space has been reserved by the user, advising the user where empty parking spaces are located in specified time periods.

15. The system according to claim 11,
wherein the choices for modes of transport kept track of by the traffic and event data notification service module are selected from the group consisting of: passenger trains; bus rapid transit; express bus service; automotive highway transport; people mover systems; local or community transit systems; rented short one-way trip vehicles; taxis; bicycles; shared ride services; and pedestrian-oriented modes, including walking; and
wherein the events and occurrences along each potential route further comprise present traffic congestion, construction-related delays, emergency events, special community events, weather concerns, and safety issues.

16. The system according to claim 11, wherein the traffic and event data notification service module for a transit authority further comprises: CATV cameras positioned upon roads, railroads, and intersections, including selectable feeds from governmental advisories to the public regarding traffic conditions along the respective routes of the user.

17. The system according to claim 11, wherein the solver layer of the computational services module comprises: IBL iLOG CPlex software running on a distributed computing architecture.

18. The system according to claim 11, wherein the solver layer of the computational services module comprises a means for solving queries based on a transit optimization model.

19. The system according to claim 11, wherein the individual smartphone application is configured to optimally receive user-input and to display results on a user's smartphone.

20. The system according to claim 11, wherein the program instructions further comprise a crowdsourcing module comprising an algorithm of crowdsourcing of a plurality of users of the system based on respective GPS coordinates of each user.

21-22. (canceled)

23. The system according to claim 11, wherein the smartphone application is configured such that the user thereof is able to purchase tickets for events within the smartphone application.

24. The system according to claim 11, wherein the traffic and event data notification service module takes into account pre-planned community events.

25. The system according to claim 11, further comprising an onboard passenger information display installed on or within a public transportation vehicle, wherein the onboard passenger information display displays the passenger count statistics, route requests, and ticket or space availability.

26. The system according to claim 25, wherein the onboard passenger display further displays the passenger information and the GPS-coordinates.

27. A system for tracking information of public transportation vehicles, the system comprising the following components to be installed on or within a public transportation vehicle:
an onboard camera;
an onboard Wi-Fi network;
an onboard tracking system;
an onboard passenger information display;
a processor;
a memory; and
a digital storage medium in operable communication with the processor and the memory, the digital storage medium comprising program instructions stored thereon that, when executed by the processor, perform the following steps:
(i) tracking local conditions of the public transportation vehicle using information obtained, either directly or through the onboard Wi-Fi network, from the onboard camera and the onboard tracking system, the conditions comprising passenger count statistics, route requests, ticket or space availability, and GPS-coordinates;
(ii) storing the local conditions on the memory;
(iii) transmitting the local conditions to a remote server having remote conditions of a plurality of other public transportation vehicles, the remote conditions comprising respective passenger count statistics, route requests, ticket or space availability, and GPS-coordinates of each public transportation vehicle of the plurality of other public transportation vehicles;
(iv) receiving the remote conditions from the remote server;
(v) storing the remote conditions on the memory;
(vi) transmitting the local conditions to the onboard passenger information display, either directly or through the onboard Wi-Fi network;
(vii) displaying the local conditions on the onboard passenger information display for viewing by passengers of the public transportation vehicle;
(vii) transmitting the remote conditions to the onboard passenger information display, either directly or through the onboard Wi-Fi network; and
(ix) displaying the remote conditions on the onboard passenger information display for viewing by passengers of the public transportation vehicle.

28. The system according to claim 27, further comprising the public transportation vehicle,
wherein the onboard camera, the onboard Wi-Fi network, the onboard tracking system, the onboard passenger information display, the processor, the memory, and the digital storage medium are installed on or within the public transportation vehicle.

29. The system according to claim 28, wherein the local conditions further comprise passenger information, and wherein the remote conditions further comprise respective passenger information of each public transportation vehicle of the plurality of other public transportation vehicles.

30. The system according to claim 27, wherein the local conditions further comprise passenger information, and wherein the remote conditions further comprise respective passenger information of each public transportation vehicle of the plurality of other public transportation vehicles.

31. The system according to claim 27, further comprising a transit authority display to be installed at a transit authority operations building and in operable communication with the remote server,
wherein the transit authority display displays the local conditions and the remote conditions for viewing by a transit authority operator.
